(19) United States
(12) Patent Application Publication
(10) Pub. No.: US 2005/0014463 A1
(43) Pub. Date: Jan. 20, 2005

(54) Internet broadcasting system and method thereof for personal telecommunication terminal

(76) Inventor: Ok-Gyun Shin, Seoul (KR)

Correspondence Address: PARK & SUTTON LLP, 3255 WILSHIRE BLVD, SUITE 1110, LOS ANGELES, CA, 90010, US

(21) Appl. No.: 10/502,998

(22) PCT Filed: Jan. 4, 2003
(86) PCT No.: PCT/KR03/00013

(30) Foreign Application Priority Data
Jan. 29, 2002 (KR) 10-2002-0005211

(51) Int. Cl. H04H 7/00; H04H 1/00

(52) U.S. Cl. 455/3.01; 455/3.06; 455/426.1

(57) ABSTRACT

Disclosed is an Internet broadcasting system and method for a personal telecommunication terminal. which provides various broadcasting contents produced and broadcast by Internet broadcasting stations to the personal telecommunication terminal through a broadcasting relay server, to allow even the personal telecommunication terminal to be provided with excellent broadcasting contents. The broadcasting relay server receives broadcasting stream packets of broadcasting contents from an Internet broadcasting station, depacketizes and buffers them, processes the buffered broadcasting streams in order to transmit them to a personal telecommunication terminal, and packetizes them again in an appropriate data size. The broadcasting relay server makes a list of information about broadcasting contents that can be provided to the personal telecommunication terminal among the received broadcasting contents, and offers the list to a mobile communication service provider server to provide it as an additional information item of the personal telecommunication terminal. A personal telecommunication terminal user searches the list provided as the additional information item of the personal telecommunication terminal to select broadcasting contents he/she wants to watch. The broadcasting relay server transmits broadcasting stream packets of the broadcasting contents selected by the personal telecommunication terminal user to the mobile communication service provider server. The mobile communication service provider server transmits the received broadcasting stream packets to the personal telecommunication terminal. The personal telecommunication terminal buffers, converts and reproduces the received broadcasting stream packets to watch them.

### TECHNICAL FIELD

The present invention relates to an Internet broadcasting system and method for a personal telecommunication terminal. More specifically, the invention relates to an Internet broadcasting system and method for a personal telecommunication terminal, which provides various broadcasting contents produced and broadcast by Internet broadcasting stations to the personal telecommunication terminal through a broadcasting relay server, to allow even the personal telecommunication terminal to be provided with excellent broadcasting contents.

1. Background Art

A personal telecommunication terminal, such as a cellular phone and PDA has been used only for receiving simple caption broadcasts, connecting to Internet in a simple form and simple voice communication up to now. However, the personal telecommunication terminal has been being developed in various forms recently such that a user listens to radio broadcasting using his/her cellular phone or downloads MP3 music files and reproduces them to hear. Especially, with the development of radio communication technology, the personal telecommunication terminal is being actively used for inquiring stock market conditions, navigation services and mobile games. Furthermore, the personal telecommunication terminal can provide even motion-picture mobile communication services.

Among radio transmission techniques employed by the personal telecommunication terminal, CDMA2000™1X used together with GSM or TDMA, which is a technique capable of transmitting and receiving radio data at a rate (144 Kbps) faster than the current mobile communication rate (14.4-64 Kbps) by 5-10 times, can transmit multimedia motion pictures and it is commercially available in Korea. Especially, CDMA2000™1X EV-DO (1×Evolution-Data only), the third-generation radio data transmission technique achieved by Luscent technologies and Sprint in early 2001, can transmit 2.4 megabit data per second to enable real multimedia radio Internet services. Accordingly, domestic cellular phone companies are moving ahead with embodiment of this technique into products, for the purpose of accomplishing commercial availability thereof in the first half of 2002.

In the meantime, Internet broadcasting is activated and Internet broadcasting contents amounting to ten thousands all over the country are transmitted through the Internet. These broadcasting contents are produced and broadcast by Internet broadcasting station servers connected to the Internet and viewers watch them through computers connected with the Internet in wired or wireless.

There exists no method of watching Internet broadcasting in real time using the personal telecommunication terminal. To watch the Internet broadcasting, a PC or a notebook computer connected to the Internet in wired or in radio must be prepared.

Moreover, Internet broadcasting restricts the number of viewers to allow only a limited number of viewers to watch the broadcasting contents because of direct influence of the bandwidth of the Internet broadcasting station server and lines providing Internet broadcasting so that a mass of people cannot watch it simultaneously. Furthermore, if a number of viewers exceeding allowable capability of the Internet broadcasting server access the server, broadcasting is frequently cut or down in the worst case.

### DISCLOSURE OF INVENTION

Accordingly, the present invention has been made in view of the above problems, and it is an object of the present invention is to provide an Internet broadcasting system and method for a personal telecommunication terminal, for allowing people to use various broadcasting contents broadcast through the Internet using their personal telecommunication terminals.

Another object of the present invention is to provide an Internet broadcasting system and method for a personal telecommunication terminal, for providing various Internet broadcasting contents produced and broadcast by Internet broadcasting servers to personal telecommunication terminals through a broadcasting relay server, to thereby stably and simultaneously offer broadcasting contents to multiple personal telecommunication terminals irrespective of performances of individual broadcasting stations on the Internet.

Yet another object of the present invention is to provide an Internet broadcasting system and method for a personal telecommunication terminal, which collects fees for watching broadcasting contents from personal telecommunication terminals to use a part of them in order to pay royalties for MP3 music files or the like, thereby solving various troubles caused by copyright.

Still another object of the present invention is to provide an Internet broadcasting system and method for a personal telecommunication terminal, for allowing people to be provided with broadcasting contents through their personal telecommunication terminals while using the telephone using a radio data transmission technique, such as CDMA2000 1X EV-DO or IMT2000 used for the personal telecommunication terminals.

To achieve these objects in an aspect of the present invention, there is provided an Internet broadcasting system for a personal telecommunication terminal, comprising an Internet broadcasting station server that produces broadcasting contents and broadcasts them through the Internet; a broadcasting relay server that receives the broadcasting contents from the Internet broadcasting station server, buffers the received broadcasting contents, processes the buffered broadcasting contents to packetize them again, and transmits the packetized contents to a mobile communication service provider; a personal telecommunication terminal that receives the packetized broadcasting contents, depacketizes and buffers them, and decodes the broadcasting contents to transform them into a visible band; and a mobile communication service provider server that receives the packetized broadcasting contents from the broadcasting relay server to transmit the broadcasting contents to the personal telecommunication terminal.

The broadcasting relay server includes an Internet broadcasting station management module for preparing connection of the Internet broadcasting station and managing the Internet broadcasting station while being connected with the Internet; a broadcasting contents management module for receiving the broadcasting contents from the Internet broadcasting station, making a list of the broadcasting contents, buffering the broadcasting contents, and packetizing the broadcasting such that the personal telecommunication terminal can watch the broadcasting contents; a relay module for offering the list made by the broadcasting contents management module to the mobile communication service provider server to provide the list as an additional information item of the personal telecommunication terminal, and requesting the mobile communication service provider server to transmit broadcasting contents selected by the personal telecommunication terminal, to allow the personal telecommunication terminal to receive the selected broadcasting contents in real time; a terminal management module for storing information about the personal telecommunication terminal, which is connected with the broadcasting relay server to request the server to transmit broadcasting contents, in a terminal information DB to manage it, and storing information, such as the kind of broadcasting contents used by the personal telecommunication terminal user, the number of times of connecting with the broadcasting contents, connection time, a period of time required for watching the broadcasting contents or the like, and a control module for controlling data flow among the modules.

Preferably, the Internet broadcasting station server includes a broadcasting content production module for producing digitalized broadcasting contents, such as audio files and video files by itself, and an Internet broadcasting module for broadcasting the produced broadcasting contents through the Internet. The Internet broadcasting station server further includes a broadcasting contents transmission module for converting the broadcasting contents into MP3 broadcasting stream packets to transmit them to the broadcasting relay server.

An internet broadcasting method for a personal telecommunication terminal, comprises the steps of a broadcasting relay server receiving broadcasting stream packets of broadcasting contents from an Internet broadcasting station, depacketizing and buffering them, processing the buffered broadcasting streams in order to transmit them to a personal telecommunication terminal, and packetizing them again in an appropriate data size; the broadcasting relay server making a list of information about broadcasting contents that can be provided to the personal telecommunication terminal among the received broadcasting contents, and offering the list to a mobile communication service provider server to provide it as an additional information item of the personal telecommunication terminal; a personal telecommunication terminal user searching the list provided as the additional information item of the personal telecommunication terminal to select broadcasting contents he/she wants to watch; the broadcasting relay server transmitting broadcasting stream packets of the broadcasting contents selected by the personal telecommunication terminal user to the mobile communication service provider server; the mobile communication service provider server transmitting the received broadcasting stream packets to the personal telecommunication terminal; and the personal telecommunication terminal buffering, converting and reproducing the received broadcasting stream packets to watch them.

### BRIEF DESCRIPTION OF THE DRAWINGS

Further objects and advantages of the invention can be more fully understood from the following detailed description taken in conjunction with the accompanying drawings in which:

FIG. 1 illustrates the concept of an Internet broadcasting system for a personal telecommunication terminal according to a preferred embodiment of the present invention;

FIG. 2 is a block diagram of the Internet broadcasting system for a personal telecommunication terminal of FIG. 1; and

FIG. 3 is a flow chart for explaining an Internet broadcasting method for a personal telecommunication terminal according to a preferred embodiment of the present invention.

### BEST MODE FOR CARRYING OUT THE INVENTION

The present invention will now be described in detail in connection with preferred embodiments with reference to the accompanying drawings.

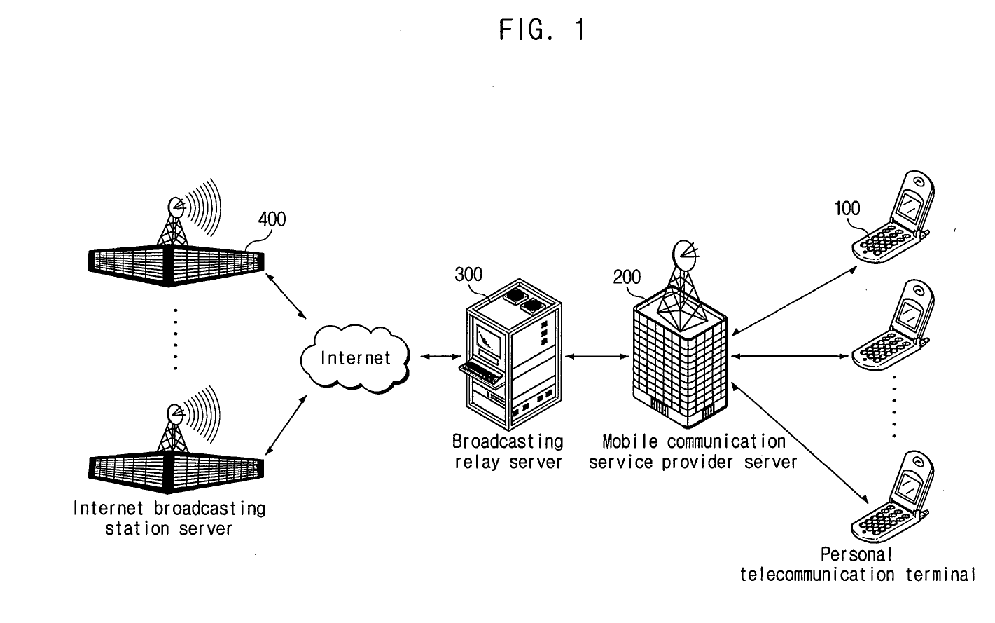

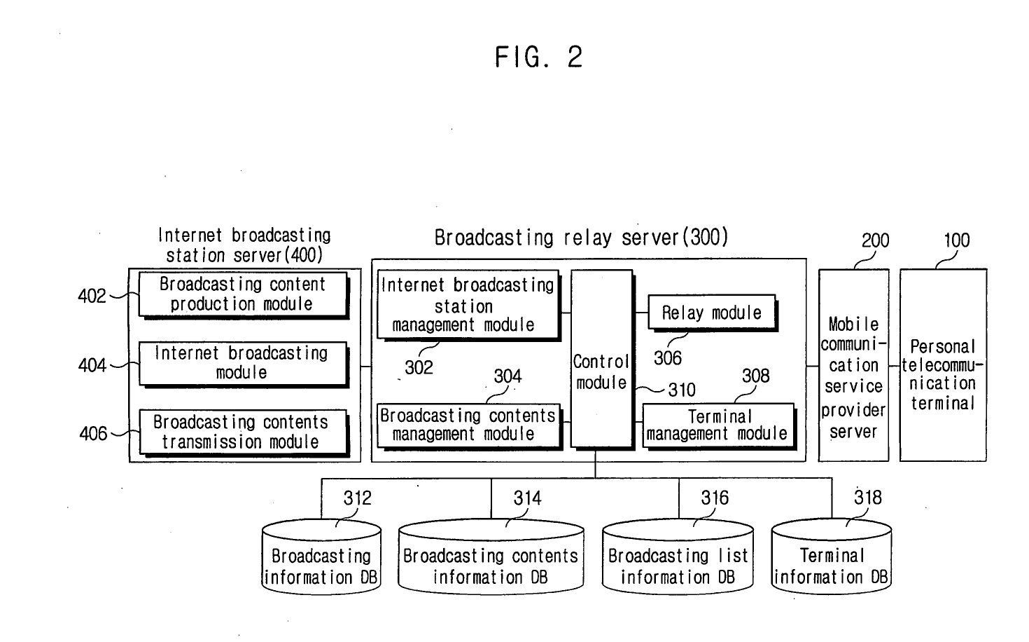

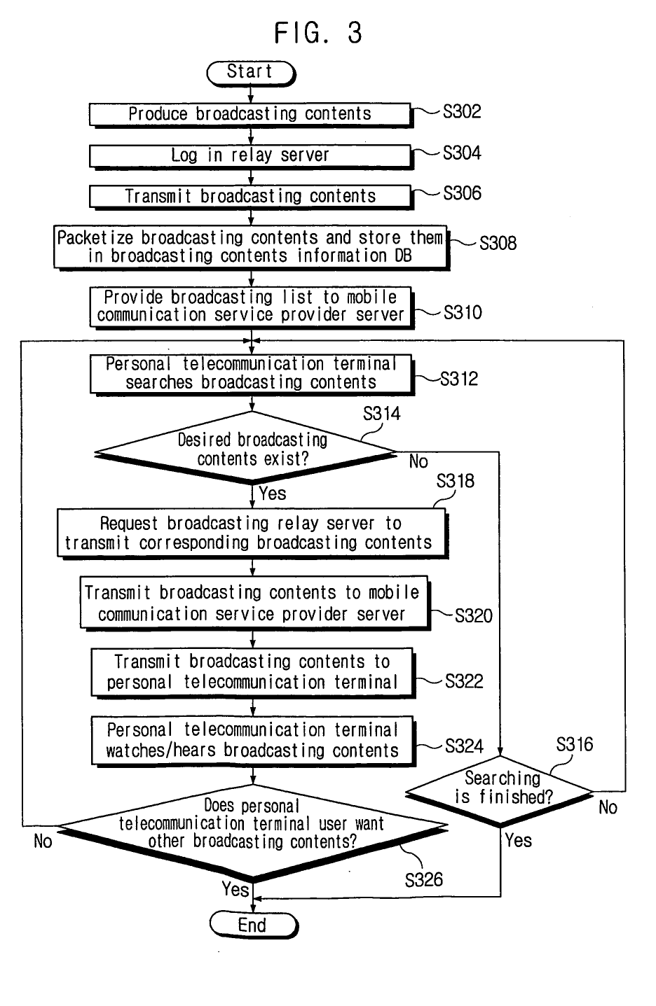

FIG. 1 illustrates the concept of an Internet broadcasting system for a personal telecommunication terminal according to a preferred embodiment of the present invention, FIG. 2 is a block diagram of the Internet broadcasting system for a personal telecommunication terminal of FIG. 1 and FIG. 3 is a flow chart for explaining an Internet broadcasting method for a personal telecommunication terminal according to a preferred embodiment of the present invention.

Referring to FIG. 1, an Internet broadcasting relay system for a personal telecommunication terminal according to the invention includes an Internet broadcasting station server 400 that broadcasts produced broadcasting contents through the Internet, a broadcasting relay server 300 that receives and buffers, processes and packetizes the broadcasting contents produced by the Internet broadcasting station server 400 to send them to a mobile communication service provider server 200, a personal telecommunication terminal 100 that depacketizes and buffers the broadcasting contents transmitted from the mobile communication service provider server 200 and decodes the depacketized and buffered broadcasting contents to transform them into a visible band, and the mobile communication service provider server 200 that accepts the packetized broadcasting contents from the broadcasting relay server 300 to transmit them to the personal telecommunication terminal.

Referring to FIG. 2, the Internet broadcasting station server 400 includes a broadcasting contents production module 402 for producing digitalized broadcasting contents, such as audio files, video files and so on by itself, and an Internet broadcasting module 404 for broadcasting the produced broadcasting contents through the Internet. Preferably, the Internet broadcasting station server 400 further includes a broadcasting contents transmission module 406 for converting the broadcasting contents into broadcasting stream packets to transmit them to the broadcasting relay server in real time. Here, the broadcasting contents produced by the Internet broadcasting station server includes audio stream files that are broadcast in such manner that contents of a script are inserted while MP3 music files are being played using Winamp, and motion-picture stream files produced using a web camera or a digital video system.

The personal telecommunication terminal 100 has the function of searching a broadcasting contents list provided by the broadcasting relay server 300, which will be described later, to select specific broadcasting contents and request the broadcasting relay server to broadcast selected broadcasting contents. In addition, the personal telecommunication terminal 100 has the function of receiving the requested broadcasting contents packetized, depacketizing the received broadcasting contents to buffer them, decoding the buffered broadcasting contents to transform them into a visible band, amplifying and outputting it. For example, in case of a personal telecommunication terminal supporting CDMA2000 1X EV-DO, a period of time required for receiving broadcasting stream data needed for listening to MP3 music broadcasting for one hour is reduced to less than tens seconds.

The mobile communication service provider server 200 provides broadcasting contents list information produced by the broadcasting relay server 300 to the personal telecommunication terminal as an additional information item thereof, and receives broadcasting contents selected by the user of the personal telecommunication terminal to transmit them to the personal telecommunication terminal 100. Here, a mobile communication service provider system operates broadcasting services in such a manner that various broadcasting contents are transmitted to personal telecommunication terminals of a plurality of subscribers who request to listen to broadcasting in real time, to which CBS (Cell Broadcasting service) technique capable of distributing a large quantity of contents to the plurality of subscribers can be applied. This technique can transmit contents to 1,300,000 subscribers, simultaneously.

The broadcasting relay server 300 includes an Internet broadcasting station management module 302, a broadcasting contents management module 304, a relay module 306, a terminal management module 308, and a control module 310.

The Internet broadcasting station management module 302 of the broadcasting relay server 300 manages the Internet broadcasting station server 400 that produces broadcasting contents to broadcast them through the Internet. Specifically, the Internet broadcasting station management module 302 registers the Internet broadcasting station server 400 as a member, gives a unique ID to each member, records information, such as the number of times of watching broadcasting contents, connection time, a period of time required for watching broadcasting contents or the like, in an Internet broadcasting station information DB 312.

The broadcasting contents management module 304 stores basic information about broadcasting contents from the Internet broadcasting station server 400 in a broadcasting contents information ID 314 to manage them. In addition, the module 304 classifies the broadcasting contents in a predetermined list such that a personal telecommunication terminal user can search the additional information item provided by the mobile communication service provider server 200 for the broadcasting contents currently broadcasting, and stores the classified information in a broadcasting list information DB 316 to manage it. Furthermore, the broadcasting contents management module 304 buffers the broadcasting contents transmitted from the Internet broadcasting station server 400 and packetizes them to allow the personal telecommunication terminal 100 to watch/hear them. Here, the module 304 stores the buffered broadcasting contents in a memory and then transmits them to the personal telecommunication terminal in real time, and receives new broadcasting contents to maintain a specific capacity continuously.

The relay module 306 transmits the broadcasting list formed by the broadcasting contents management module 304 to the mobile communication service provider server such that the list is provided as the additional information item of the personal telecommunication terminal. In addition, when the personal telecommunication terminal user searches the broadcasting list provided as the additional information item to select specific broadcasting contents and requests to broadcast them, the relay module 306 transmits the selected broadcasting contents to the mobile communication service provider server 200 to allow the user to watch/hear the broadcasting contents through his/her personal telecommunication terminal 100.

The terminal management module 308 stores information. about the personal telecommunication terminal 100, which is connected to the broadcasting relay server to request the server to transmit broadcasting contents, in a terminal information DB 318 and manages the stored information. Furthermore, the terminal management module 308 stores information, such as the kind broadcasting contents used by the personal telecommunication terminal user, the number of times of using the contents, connection time, the time required for using the contents, and analyzes the broadcasting contents used by the terminal user to record update information about broadcasting contents which the user frequently watches/hears and transmit it. Here, the personal telecommunication terminal user can be provided with the information about the broadcasting contents he/she frequently uses preferentially when searching the broadcasting list.

Finally, the control module 310 controls data flow among the modules.

A method of transmitting Internet broadcasting contents to the personal telecommunication terminal according to the present invention is explained below with reference to FIG. 3.

First of all, the Internet broadcasting station server 400 produces a variety of broadcasting contents including audio and video files at step S302. When the Internet broadcasting station server is connected with the broadcasting relay server 300 and inputs the membership ID thereof in order to provide the produced broadcasting contents to the broadcasting relay server, the broadcasting station management module of the broadcasting relay server 300 confirms whether or not the Internet broadcasting station server 400 has been registered, at step S304. When the Internet broadcasting station server has not been registered, the broadcasting management module informs the Internet broadcasting station server 400 that it cannot use the broadcasting relay server and makes the server 400 sign in the broadcasting relay server through a separate registration procedure. The Internet broadcasting station server inputs broadcasting station information, basic information about contents or the like when it signs in, and the broadcasting station management module stores the information in the Internet broadcasting station information DB.

The Internet broadcasting station server which has been registered transmits its broadcasting contents in the form of broadcasting stream packets to the broadcasting relay server 300 at step S306.

The broadcasting relay server 300 buffers the broadcasting stream packets of the broadcasting contents sent from the Internet broadcasting station server 400, processes the broadcasting stream packets to packetize them again in an appropriate data size in order to transmit them to the personal telecommunication terminal 100, and waits for transmission of the broadcasting stream packets to the mobile communication service provider, at step S308. That is, the broadcasting relay server 300 buffers the broadcasting contents in the memory to transmit them and receives new broadcasting contents to continuously maintain a specific amount of contents.

Then, the broadcasting relay server makes a list of information about broadcasting contents that can be provided to the personal telecommunication terminal 100 among the broadcasting contents stored in the broadcasting contents information DB 314, and offers the list to the mobile communication service provider server 200 to provide it as the additional information item of the personal telecommunication terminal 100 at step S310.

In the meantime, the personal telecommunication terminal user searches the list provided as the additional information item of the personal telecommunication terminal 100 for the broadcasting contents he/she wants to watch/hear, at step S312, and selects the searched broadcasting contents to request the broadcasting relay server 300 to transmit them to him/her at steps S314 and S318. Here, if there is no broadcasting contents the user wants, the user searches the list again or finishes the searching operation, at step S316.

The broadcasting relay server 300 that accepts the request of the user to transmit the broadcasting contents sends corresponding packetized broadcasting contents to the mobile communication service provider server 200 at step S320. Upon completion of transmission of the broadcasting contents, the broadcasting relay server stores the phone number of the personal telecommunication terminal to which the broadcasting contents have been transmitted, connection time, a period of time required for the user watch/hear the contents and information about the broadcasting. contents in the terminal information DB 318. According to the stored information, the mobile communication service provider server asks for the personal telecommunication terminal user to pay a charge for using the information. A part of the charge settled by the user is given to the Internet broadcasting station server providing the broadcasting contents.

The mobile communication service provider server 200 transmits the received broadcasting contents to the personal telecommunication terminal 100 at step S322. The personal telecommunication terminal 100 that has accepted the broadcasting contents depacketizes the packetized broadcasting contents to buffer them, decodes the buffered broadcasting contents to transform them into a visible band, amplifies it to output it to an earphone or a speaker at step S324.

In the case where the personal telecommunication terminal user wants to watch/hear other broadcasting contents, the procedure goes to the step S312 to search the broadcasting list.

Furthermore, the broadcasting relay server 300 analyzes the broadcasting contents used by the personal telecommunication terminal user or directly transmits update information about broadcasting contents the user frequently uses, inputted when the user registers as a member, to the personal telecommunication terminal so that the personal telecommunication terminal user can save the time required for selecting desired broadcasting contents. Industrial Applicability As described above, the Internet broadcasting system for a personal telecommunication terminal according to the present invention can be provided with a variety of broadcasting contents broadcasting through the Internet using the personal telecommunication terminal in real time.

Furthermore, the present invention can provide various broadcasting contents produced and broadcast by the Internet broadcasting server to the personal telecommunication terminal through the broadcasting relay server and the mobile communication system to simultaneously offer the broadcasting contents to a plurality of personal telecommunication terminals irrespective of performances of individual Internet broadcasting servers. Accordingly, Internet broadcasting residing in the domain of unproductive hobby activities up to now can be converted into productive industrial activities. In addition, commercial mass media in the form of Internet broadcasting can appear.

Moreover, the personal telecommunication terminal user is charged for using broadcasting contents so that the charge can be invested in the development of broadcasting contents more improved and various troubles caused by copyright related with MP3 music files or the like can be solved.

Furthermore, the present invention can employ the data transmission technique of CDMA2000 1X EV-DO used for the personal telecommunication terminal so that the user can be provided with broadcasting contents while using the telephone. In addition, the broadcasting relay server analyzes the personal telecommunication terminal user's state of connection with the broadcasting contents to provide update information about the broadcasting contents the user frequently uses so that the personal telecommunication terminal user can save expenses and time required for selecting broadcasting contents.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An Internet broadcasting system for a personal telecommunication terminal, comprising:
an Internet broadcasting station server that broadcasts broadcasting contents through the Internet;
a broadcasting relay server that receives the broadcasting contents from the Internet broadcasting station server, buffers the received broadcasting contents, processes the buffered broadcasting contents to packetize them again, and transmits the packetized contents to a mobile communication service provider;
a personal telecommunication terminal that receives the packetized broadcasting contents, depacketizes and buffers them, and decodes the broadcasting contents to transform them into a visible band; and
a mobile communication service provider server that receives the packetized broadcasting contents from the broadcasting relay server to transmit the broadcasting contents to the personal telecommunication terminal.

2. The Internet broadcasting system for a personal telecommunication terminal as claimed in claim 1, wherein the broadcasting relay server comprises:
an Internet broadcasting station management module for preparing connection of the Internet broadcasting station and managing the Internet broadcasting station while being connected with the Internet;
a broadcasting contents management module for receiving the broadcasting contents from the Internet broadcasting station, making a list of the broadcasting contents, buffering the broadcasting contents, and packetizing the broadcasting such that the personal telecommunication terminal can watch the broadcasting contents;
a relay module for offering the list made by the broadcasting contents management module to the mobile communication service provider server to provide the list as an additional information item of the personal telecommunication terminal, and requesting the mobile communication service provider server to transmit broadcasting contents selected by the personal telecommunication terminal, to allow the personal telecommunication terminal to receive the selected broadcasting contents in real time;
a terminal management module for storing information about the personal telecommunication terminal, which is connected with the broadcasting relay server to request the server to transmit broadcasting contents, in a terminal information DB to manage it, and storing information about broadcasting contents the personal telecommunication terminal user has used; and
a control module for controlling data flow among the modules.

3. The Internet broadcasting system for a personal telecommunication terminal as claimed in claim 1, wherein the Internet broadcasting station server comprises:
a broadcasting content production module for producing digitalized broadcasting contents, such as audio files and video files by itself;
an Internet broadcasting module for broadcasting the produced broadcasting contents through the Internet; and
a broadcasting contents transmission module for converting the broadcasting contents into broadcasting stream packets in real time to transmit the broadcasting stream packets to the broadcasting relay server.

4. An Internet broadcasting method for a personal telecommunication terminal, comprising the steps of:
a step in which a broadcasting relay server receives broadcasting stream packets of broadcasting contents from an Internet broadcasting station, depacketizes and buffers them, processes the buffered broadcasting streams in order to transmit them to a personal telecommunication terminal, and packetizes them again in an appropriate data size;
a step in which the broadcasting relay server makes a list of information about broadcasting contents that can be provided to the personal telecommunication terminal among the received broadcasting contents, and offers the list to a mobile communication service provider server to provide it as an additional information item of the personal telecommunication terminal;
a step in which a personal telecommunication terminal user searches the list provided as the additional information item of the personal telecommunication terminal to select broadcasting contents he/she wants to watch;
a step in which the broadcasting relay server transmits broadcasting stream packets of the broadcasting contents selected by the personal telecommunication terminal user to the mobile communication service provider server;
a step in which the mobile communication service provider server transmits the received broadcasting stream packets to the personal telecommunication terminal; and
a step in which the personal telecommunication terminal buffers, converts and reproduces the received broadcasting stream packets to watch them.

5. The Internet broadcasting method for a personal telecommunication terminal as claimed in claim 4, further comprising the step of analyzing the broadcasting contents used by the personal telecommunication terminal user, to transmit update information about broadcasting contents the user frequently watches.
